(19) United States
(12) Patent Application Publication
(10) Pub. No.: US 2005/0274161 A1
(43) Pub. Date: Dec. 15, 2005

(54) Wrist protectable handcuffs

(76) Inventors: Jeong Su Kwon, Seoul (KR); Ki Suk Kim, Seoul (KR)

Correspondence Address: Porter, Wright, Morris & Arthur LLP;ATTN: Intellectual Property Department, 41 South High Street, 28th Floor, Columbus, OH, 43215-6194, US

(21) Appl. No.: 11/152,819

(22) Filed: Jun. 14, 2005

(30) Foreign Application Priority Data
Jun. 14, 2004 (KR) 2004-16654
Jul. 6, 2004 (KR) 2004-19196
Aug. 30, 2004 (KR) 2004-24709

(51) Int. Cl. E05B 75/00

(52) U.S. Cl. 70/16

(57) ABSTRACT

A wrist protectable handcuff according to the present invention comprises a movable arm formed in a semi-circle shape to have an annular circumferential surface; a pair of fixed arms formed in a semi-circle shape to have annular circumferential surfaces and integrally formed with rectangular base bodies; the rectangular base bodies which accommodate frame plates, a partition plate, a pair of pawl pieces and a leaf spring therein to form a passageway through which the movable arm can move; and protecting elements provided on annular circumferential surfaces of the movable arm and the fixed arms.

### FIELD OF THE INVENTION

The present invention relates to wrist protectable handcuffs, and more particularly to wrist protectable handcuffs which have protecting elements in direct contact with a human wrist so that the wrist can be effectively protected from the metallic body of the handcuff.

### BACKGROUND OF THE INVENTION

Conventionally, a handcuff comprises a movable arm formed in a semi-circle shape to have an annular circumferential surface; a pair of fixed arms formed in a semi-circle shape to have annular circumferential surfaces and integrally formed with rectangular base bodies; and the rectangular base bodies which accommodate frame plates, a partition plate, a pair of pawl pieces and a leaf spring therein to form a passageway through which the movable arm can move.

The movable arm is provided at its free end with a ratchet portion formed with dual line or three lines of teeth which is arranged to be movably engaged with the pawl pieces of the rectangular base bodies.

Thus, the handcuff is put on a wrist of a suspect in a manner that the movable arm is pushed into the rectangular base bodies integrally formed with the fixed arms and then the ratchet portion of the movable arm engages with the pawl pieces formed in the rectangular base bodies, thereby forming a circle shape by connection of the movable arm and the fixed arms.

As the annular circumferential surfaces of the movable arm and the fixed arms are in direct contact with the suspect's wrist, the suspect cannot move the wrist freely. However, as the annular circumferential surfaces are made of metallic material, if impact or hit is given on the wrist, the wrist can be hurt or bruised.

### SUMMARY OF THE INVENTION

The object of the present invention is to solve the above disadvantages of the conventional handcuff and to provide a wrist protectable handcuff which can protect a human wrist in direct contact with the annular circumferential surfaces of the movable arm and the fixed arms by forming protecting elements on the annular circumferential surfaces.

Another object of the present invention is to provide a wrist protectable handcuff wherein the protecting elements are integrally formed with the annular circumferential surfaces of the moving arm and the fixed arms.

A further object of the present invention is to provide a wrist protectable handcuff wherein the protecting elements are formed on inner sides of the annular circumferential surfaces of the moving arm and the fixed arms.

A further object of the present invention is to provide a wrist protectable handcuff wherein the protecting elements are protruded at predetermined intervals on the inner sides of the annular circumferential surfaces of the moving arm and the fixed arms.

A further object of the present invention is to provide a wrist protectable handcuff wherein the annular circumferential surfaces of the movable arm and the fixed arms are covered with a coat as one of the protecting elements.

In order to achieve the above objects, a wrist protectable handcuff according to the present invention comprises a movable arm formed in a semi-circle shape to have an annular circumferential surface; a pair of fixed arms formed in a semi-circle shape to have annular circumferential surfaces and integrally formed with rectangular base bodies; the rectangular base bodies which accommodate frame plates, a partition plate, a pair of pawl pieces and a leaf spring therein to form a passageway through which the movable arm can move; and protecting elements provided on annular circumferential surfaces of the movable arm and the fixed arms.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention, wherein:

FIG. 1 is a perspective view of wrist protectable handcuffs according to the present invention;

FIG. 2 is a front view of the wrist protectable handcuffs according to the present invention;

FIG. 3 is a disassembled perspective view of a piece of the wrist protectable handcuffs according to the present invention;

FIGS. 4a to 4d are vertical sectional views showing states where a protecting element is attached to an annular circumferential surface of a movable arm or fixed arms according to the present invention; and

FIGS. 5a to 5c are plane views showing states where a protecting element is attached to the annular circumferential surface of the movable arm according to the present invention; and

FIGS. 6a and 6b are perspective views showing a manner that a protecting element is attached to the movable arm.

### DETAILED DESCRIPTION OF THE PREFERRED EMBODIMENTS

Reference will now be made in detail to a preferred embodiment of the present invention in conjunction with the accompanying drawings.

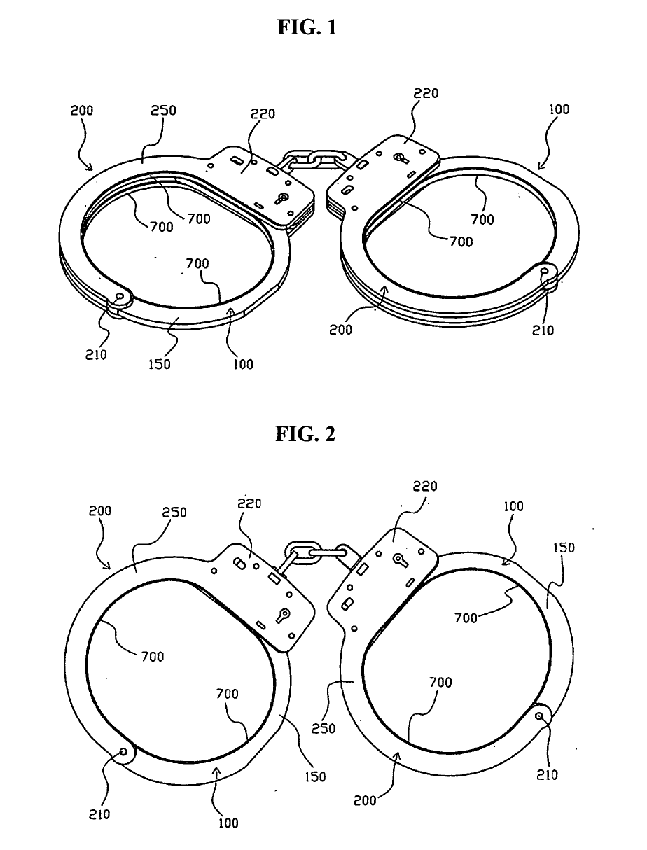

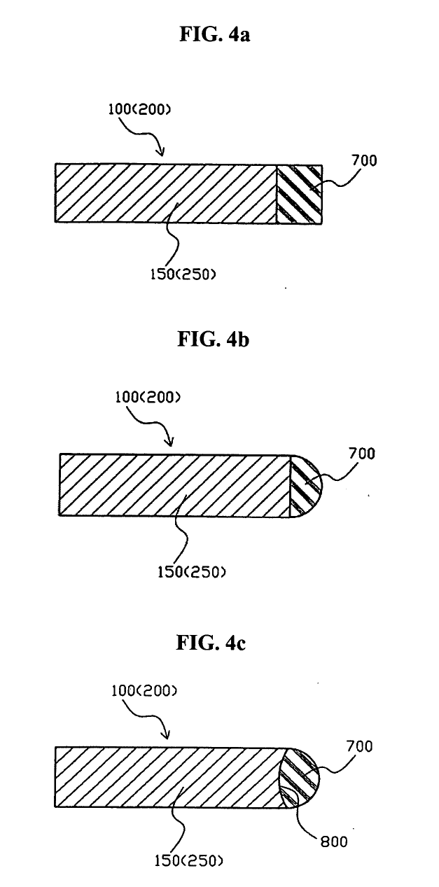

As shown in FIGS. 1 to 3, a handcuff generally comprises a movable arm (100), a pair of fixed arms (200) and rectangular base bodies (220) having a partition plate (300), a pair of pawl pieces (400), a leaf spring (500) and frame plates (600) therein.

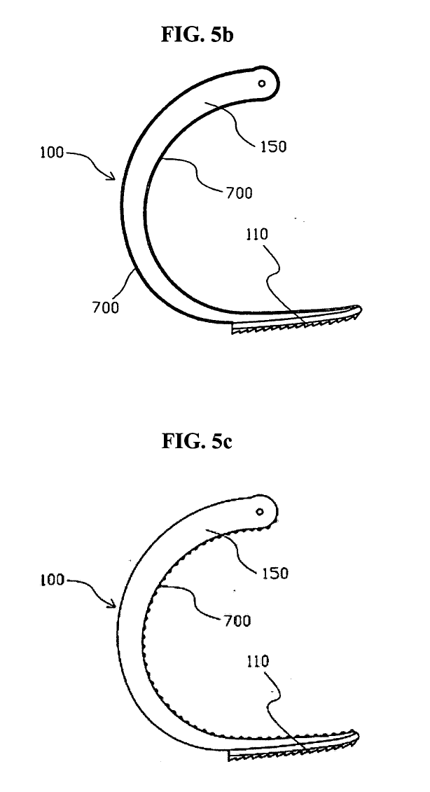

The movable arm (100) is formed in a semi-circle shape and has a ratchet portion (110) at the free end thereof formed with dual line or three lines of teeth which are divided by partition grooves as shown in FIGS. 5a to 5c.

The movable arm (100) is pivotably connected to the fixed arms (200) at the other end thereof by a pivot pin (210) so that the movable arm (100) can move with respect to the fixed arms (200), centering around the pivot pin (210).

The fixed arms (200) are also formed in a semi-circle shape and consist of two symmetrical parts, which are pivotably connected at free ends thereof to the movable arm (100) by the pivot pin (210) and are provided at their other ends with the rectangular base bodies (220) integrally formed therewith.

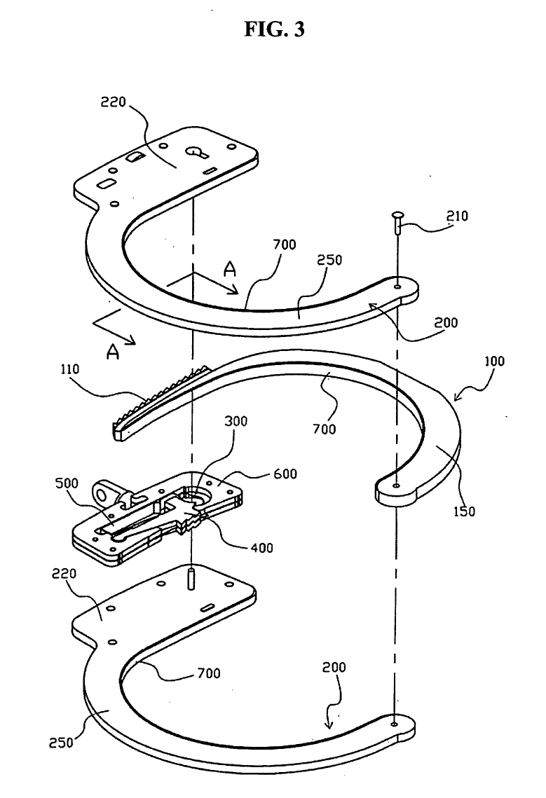

The rectangular base bodies (220) are provided with the partition plate (300), the pawl pieces (400), the leaf spring (500) and the frame plates (600) therein to form a passageway through which the movable arm (100) can move as shown in FIGS. 1 and 2.

According to the present invention, protecting elements (700) are provided on annular circumferential surfaces (150, 250) of the movable arm (100) and the fixed arms (200).

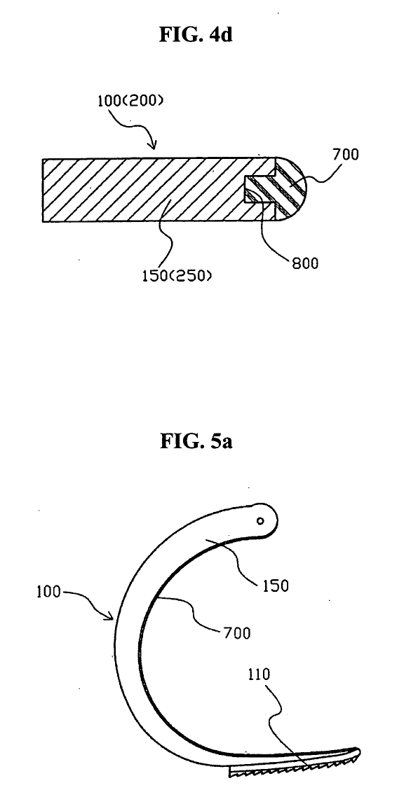

Further, as shown in FIGS. 4a to 4d, the protecting elements (700) may be integrally formed with the annular circumferential surfaces (150, 250) of the movable arm (100) and the fixed arms (200).

As in FIGS. 4a and 4b, the protecting element (700) may have a section formed in a rectangular shape or in a semi-circle shape.

Also, as shown in FIGS. 4c and 4d, the annular circumferential surfaces (150, 250) can be provided with grooves (800), so that the protecting elements (700) having corresponding connecting structure can be fitted into the grooves (800).

In addition, as shown in FIGS. 5a and 5b, the protecting elements (700) may be formed on an inner side of the annular circumferential surface (150) of the movable arm (100).

As shown in FIG. 5c, the protecting elements (700) may be formed to protrude at predetermined intervals on the inner side of the annular circumferential surfaces (150) of the movable arm (100).

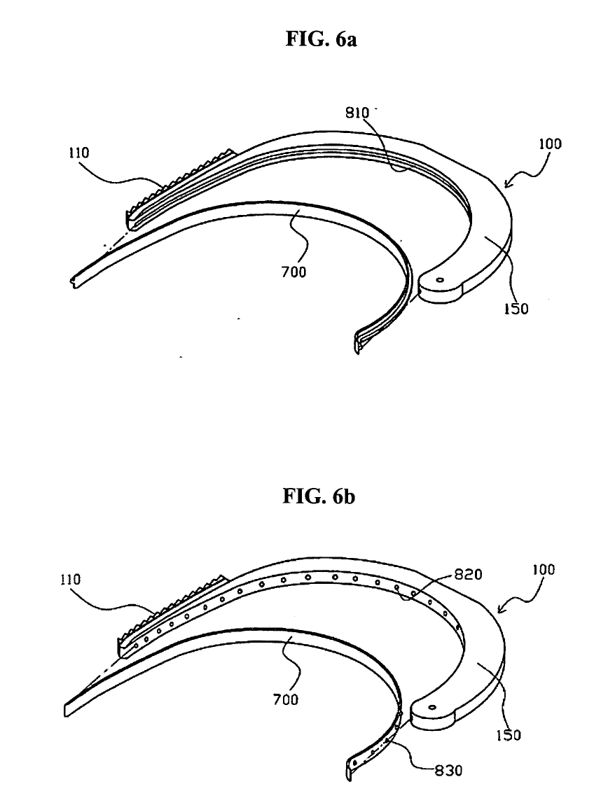

Further, as shown in FIGS. 6a and 6b, the protecting elements (700) may be formed by injection molding for assembly into the annular circumferential surface (150). FIG. 6a shows that the protecting element (700) is fitted into a recess (810) which has a slope surface for preventing the detachment of the protecting element (700) from the annular circumferential surface (150). Also, FIG. 6b shows that the protecting element (700) having protrusions (830) is fitted into holes (820) formed on the annular circumferential surface (150). The holes (820) and the protrusions (830) may be formed in a spiral shape for firm fitting.

The protecting elements (700) can be made of nonmetallic material, for example, rubber, silicon, plastic, or textile such as felt. Also, the protecting elements (700) may be made of leather, sponge, cloth, paper, latex, etc., as long as the material is soft and smooth.

Leather and sponge may be attached to the annular circumferential surfaces (150, 250) by adhesives.

Textile and paper may be attached to the annular circumferential surfaces (150, 250) by compression molding in a form attachable to the annular circumferential surfaces and then by using adhesives.

Further, the protecting elements (700) made of leather, textile or paper may be attached by using fixing means such as screws or rivets.

According to another embodiment of the present invention, the protecting element (700) may be a coating film. The coating film may be made of nonmetallic material, preferably epoxy.

The epoxy may be mixed with a curing agent and a thinner and the mixture is applied to the annular circumferential surfaces (150, 250). If such coating is dried for 30 minutes at the temperature of 120, an epoxy film can be formed on the annular circumferential surfaces (150, 250).

The epoxy film has excellent chemical resistance and abrasion resistance, and it can be manufactured to have various colors by adding pigments of various colors.

Further, the epoxy film can be laminated in multiple layers by applying the epoxy mixture several times, in which case cushioning effects can be obtained.

According to the present invention, a noctilucent layer may be formed on the annular circumferential surfaces (150, 250) of the movable arm (100) and the fixed arms (200).

The noctilucent layer (700) may be integrally formed with the epoxy film layer or can be formed on the surface of the epoxy film. Also, separate noctilucent layers may be provided on the annular circumferential surfaces (150, 250).

With the noctilucent layer, the position of the handcuffs can be easily distinguished and it will become easier to put the handcuffs on the wrist of a suspect even at dark places.

Therefore, according the present invention, a wrist protectable handcuff is provided which can effectively protect the human wrist in direct contact with the annular circumferential surfaces of the movable arm and the fixed arms by forming protecting elements on the annular circumferential surfaces.

It will be apparent to those skilled in the art that various modifications and variations can be made to the present invention without departing from the spirit and scope of the invention. The present invention covers the modifications and variations thereof provided they come within the scope of the appended claims and their equivalents.

1. A wrist protectable handcuff comprising a movable arm (100) formed in a semi-circle shape to have an annular circumferential surface (150); a pair of fixed arms (200) formed in a semi-circle shape to have annular circumferential surfaces (250) and integrally formed with rectangular base bodies (220); the rectangular base bodies (220) which accommodate frame plates (600), a partition plate (300), a pair of pawl pieces (400) and a leaf spring (500) therein to form a passageway through which the movable arm (100) can move; and protecting elements (700) provided on annular circumferential surfaces (150, 250) of the movable arm (100) and the fixed arms (200).

2. The wrist protectable handcuff as claimed in claim 1, wherein the protecting elements (700) are integrally formed with the annular circumferential surfaces (150, 250) of the moving arm (100) and the fixed arms (200).

3. The wrist protectable handcuff as claimed in claim 2, wherein the protecting element is a coating film.

4. The wrist protectable handcuff as claimed in claim 3, wherein the coating film is an epoxy film.

5. The wrist protectable handcuff as claimed in claim 2, wherein the protecting elements (700) are made of at least one selected from a group including leather, sponge, textile, paper, latex, rubber, silicon and plastic.

6. The wrist protectable handcuff as claimed in claim 1, wherein the protecting elements (700) are formed on inner sides of the annular circumferential surfaces (150, 250) of the moving arm (100) and the fixed arms (200).

7. The wrist protectable handcuff as claimed in claim 6, wherein the protecting element is a coating film.

8. The wrist protectable handcuff as claimed in claim 7, wherein the coating film is an epoxy film.

9. The wrist protectable handcuff as claimed in claim 6, wherein the protecting elements (700) are made of at least one selected from a group including leather, sponge, textile, paper, latex, rubber, silicon and plastic.

10. The wrist protectable handcuff as claimed in claim 1, wherein the protecting elements (700) are protruded at predetermined intervals on the inner sides of the annular circumferential surfaces (150, 250) of the moving arm (100) and the fixed arms (200).

11. The wrist protectable handcuff as claimed in claim 10, wherein the protecting element is a coating film.

12. The wrist protectable handcuff as claimed in claim 11, wherein the coating film is an epoxy film.

13. The wrist protectable handcuff as claimed in claim 10, wherein the protecting elements (700) are made of at least one selected from a group including leather, sponge, textile, paper, latex, rubber, silicon and plastic.

14. The wrist protectable handcuff as claimed in claim 1, wherein the protecting element is a coating film.

15. The wrist protectable handcuff as claimed in claim 14, wherein the coating film is an epoxy film.

16. The wrist protectable handcuff as claimed in claim 15, wherein the coating film is formed with a noctilucent layer.

17. The wrist protectable handcuff as claimed in claim 14, wherein the coating film is formed with a noctilucent layer.

18. The wrist protectable handcuff as claimed in claim 1, wherein the protecting elements (700) are made of at least one selected from a group including leather, sponge, textile, paper, latex, rubber, silicon and plastic.
